(19) United States
(12) Patent Application Publication
(10) Pub. No.: US 2026/0356515 A1
(43) Pub. Date: Nov. 12, 2026

(54) MOBILE PLATFORM STACKING ASSEMBLY

(71) Applicant: Perennial Autonomy, LLC, Menlo Park, CA (US)

(72) Inventors: Christian Johan Owen HANDLEY, San Francisco, CA (US); David SCHNELLE, Palo Alto, CA (US); Jaffer ALI, Cleveland, OH (US)

(21) Appl. No.: 19/672,527

(22) Filed: May 8, 2026

Related U.S. Application Data
(63) Continuation-in-part of application No. 19/542,624, filed on Feb. 17, 2026.
(60) Provisional application No. 63/960,687, filed on Jan. 14, 2026.
(60) Provisional application No. 63/910,760, filed on Nov. 3, 2025.
(60) Provisional application No. 63/854,392, filed on Jul. 30, 2025.
(60) Provisional application No. 63/815,810, filed on Jun. 1, 2025.
(60) Provisional application No. 63/807,413, filed on May 16, 2025.
(60) Provisional application No. 63/803,081, filed on May 9, 2025.

(51) Int. Cl. B64U 70/92; B64U 10/13; B64U 60/50; B64U 80/40

(52) U.S. Cl. CPC B64U 70/92; B64U 10/13; B64U 60/50; B64U 80/40

(57) ABSTRACT

A mobile platform stacking assembly is disclosed that includes a base, guide rails extending from the base, and one or more mobile platforms configured to slide along the guide rails via supporting members. Impact absorbing boots are positioned for engagement with the supporting members during stacking. Each impact absorbing boot includes axial openings that receive a corresponding guide rail and permit axial movement. The impact absorbing boots include an engaging portion for coupling to a support member and a shock absorbing portion configured to deform under axial impact using lateral compression cavities or a slotted spring structure.

### CROSS-REFERENCE TO RELATED APPLICATION

This non-provisional utility application claims priority to provisional patent application number 63/910,760, entitled “MOBILE PLATFORM STACKING ASSEMBLY” and filed on Nov. 3, 2025, provisional patent application number 63/854,392, entitled “DUAL-PURPOSE BOOT AND METHOD OF MANUFACTURE” and filed on Jul. 30, 2025, provisional patent application number 63/807,413, entitled “LAUNCHING CONTAINER USING SUPPORTS FOR MOBILE PLATFORMS” and filed on May 16, 2025, provisional patent application number 63/803,081, entitled “MOBILE PLATFORM DEPLOYMENT METHOD AND SYSTEM” and filed on May 9, 2025, provisional patent application number 63/815,810, entitled “LAUNCHING CONTAINER ASSEMBLY FOR MOBILE PLATFORMS” and filed on Jun. 1, 2025, provisional patent application number 63/960,687, entitled “CONTAINER ASSEMBLY WITH SECURING MECHANISM” and filed on Jan. 14, 2026, non-provisional patent application number 19/542,624, entitled “STACKING SPACER FOR MOBILE PLATFORMS” and filed on Feb. 17, 2026, each of which is incorporated herein in its entirety by reference.

### BACKGROUND

Mobile platforms may be transported or arranged in stacked configurations. During such operations, portions of a mobile platform may contact the ground or another surface, damaging the mobile platform.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Systems and methods for a mobile platform stacking assembly are provided: The mobile platform stacking assembly includes a base, a pair of guide rails extending vertically from the base, and a mobile platform slidably engaged with the pair of guide rails via a pair of supporting members coupled to opposing sides of the mobile platform. The mobile platform stacking assembly further includes a pair of impact absorbing boots configured to absorb a defined threshold of mechanical energy from axial impact resulting from the mobile platform being slid down the pair of guide rails onto the base. Each of the pair of impact absorbing boots includes an first axial opening and the second axial opening configured to allow axial movement of a guide rail therethrough.

### BRIEF DESCRIPTION OF THE DRAWINGS

The present description will be better understood from the following detailed description read considering the accompanying drawings, wherein:

FIGS. 1 and 2 are perspective views illustrating an example dual-purpose boot;

FIGS. 3A and 3B illustrate an example shock absorbing portion;

FIG. 4 illustrates an example of a stacking of mobile platforms with dual-purpose boots;

FIG. 5 is a perspective view illustrating an example dual-purpose boot engaging a supporting member;

FIGS. 6A, 6B. and 7 are perspective views illustrating an example mobile stacking structure;

FIG. 8 is a perspective view illustrating an example mobile platform;

FIG. 9 is an example of a stacking of mobile platforms with dual-purpose boots on a mobile stacking structure; and

FIG. 10 is a flowchart illustrating an example method of stacking a plurality of mobile platforms on a mobile platform stacking structure.

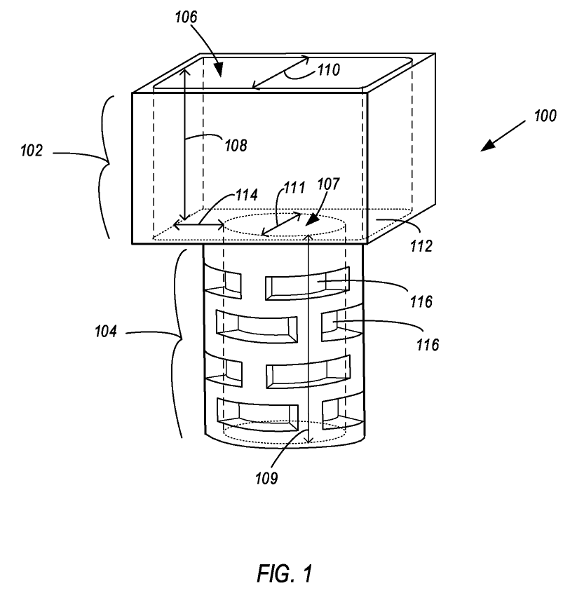

Corresponding reference characters indicate corresponding parts throughout the drawings. In FIGS. 1 -10, the systems are illustrated as schematic drawings. The drawings may not be to scale. Any of the figures may be combined into a single example or embodiment.

### DETAILED DESCRIPTION

The present disclosure describes a dual-purpose boot for use with a mobile platform. In some embodiments, the boot is configured to be coupled to a support member of the mobile platform and to provide both an engagement interface and a shock-absorbing interface. The boot may be used during operations in which the mobile platform is landed, handled, transported, stored, stacked, or otherwise positioned relative to another platform or support structure.

Some example of the shock absorbing components described herein are specifically tailored for a particular object, such as a mobile platform, and incorporate a unique combination of materials and design features to address challenges associated with both landing and stacking.

In some examples, the system utilizes thermoplastic polyurethane (TPU) for the construction of the shock absorbing components (e.g., dual-purpose boots) described herein, a material choice that is not commonly found in existing general stacking systems. TPU's low Young's modulus and specific Shore hardness provide a balance between flexibility and durability, which is particularly advantageous for absorbing impact forces during landings as well as stacking.

Example dual-purpose boots described herein include a slotted spring design within the dual-purpose boot, enhancing impact absorbing by allowing controlled deformation. This design distributes impact forces over a larger area and increases a time over which deceleration occurs.

In addition, examples of the system use an interference fit for the dual-purpose boots to allow for easy attachment and detachment, facilitating maintenance and quick replacement. The modular approach described herein is specifically optimized to ensure that the dual-purpose boots remain with the mobile platform during takeoff.

Furthermore, the dual-purpose boots described herein are optimized for specific weight and drop height parameters, such as absorbing an impact of a 5-kilogram mobile platform dropped from a height of one meter during the stacking process. This level of optimization for specific conditions unique to a particular object, such as a mobile platform, is not found in conventional stacking systems or landing mechanisms.

Aspects of the disclosure are operable in a wide range of applications including, but not limited to, mobile platforms. For example, the dual-purpose boots described herein can be designed and used specifically for a variety of components, such as tripod-mounting devices, portable generators and compressors, stackable storage racks, pallets systems or dollies, kickstands on motorcycles and bicycles, roof racks, furniture legs, appliances, audio systems/speakers, crutches, walkers, and canes.

An example implementation of the dual-purpose boot features two separate portions, an engaging portion and a shock absorbing portion, which are monolithically formed from elastomeric material. The engaging portion is design to receive an end of a support member of the mobile platform within an axial opening of the engaging portion (e.g., like a boot), while a shoulder positioned between the engaging portion and the shock absorbing portion prevents the support member from moving into an axial opening of the shock absorbing portion, which has width shorter than width of the axial opening of the engaging portion. Thus, a top portion of the dual-purpose boot (e.g., the engaging portion) is designed to secure the dual-purpose boot to the end of the support member while the bottom portion of the dual-purpose boot is designed to provide impact absorbing. To enhance impact absorption unique to both landing and stacking, the shock absorbing portion includes a plurality of lateral compression cavities in a sidewall of the shock absorbing portion, with a location and size of each of the compression cavities being specific to the impact and vibrations the mobile platform experiences during landings and stackings.

While described for convenience in the context of two dual-purpose boots located at a bottom of respective support members of a mobile platform, aspects of the disclosure are operable with any quantity and size of dual-purpose boots. For example, the same dual-purpose boots at the bottom end of the support members can also be attached to an opposite top end of the support members, further enhancing absorbing during stacking or even crash landings.

In an implementation, a mobile platform landing and/or stacking structure includes a base and a pair of guide rails extending vertically from the base, enabling a mobile platform to slidably engage the pair of guide rails via a pair of supporting members coupled to opposing sides of the mobile platform. The base further includes a pair of guide rail mounts physically coupled to the base and configured to support the pair of guide rails upon insertion into respective ones of the pair of guide rail mounts. The pair of guide rail mounts have a guide rail opening extending therethrough such that upon insertion into the respective ones of the guide rail mounts, each of the pair of guide rails extend through the top surface of the base into the respective ones of the guide rail mounts. Other implementations contemplate additional or fewer guide rails, depending on the configuration of the mobile platform.

In an implementation, a mobile platform landing and stacking structure comprises a stacking assembly configured to accommodate a plurality of mobile platforms in a vertical arrangement. Each mobile platform is equipped with dual-purpose boots constructed from a 3D printable TPU material, characterized by a Shore hardness of approximately 85, which provides a balance between flexibility and durability. The dual-purpose boots are advantageously designed to absorb impact forces during landing and stacking thereby mitigating potential damage to the mobile platform structure.

In another implementation, the dual-purpose boots feature a slotted spring design that enhances impact absorbing capabilities. The slots are strategically positioned to allow for controlled deformation, distributing impact forces over a larger area and increasing a time over which deceleration occurs. This design ensures that the dual-purpose boots do not bottom out or yield, allowing for repeated use over multiple landing and stacking cycles.

In yet another implementation, the dual-purpose boots are designed to slide over support members of the mobile platform’s landing gear using an interference fit. This modular design facilitates easy attachment and detachment, allowing for straightforward maintenance and replacement. The interference fit ensures that the dual-purpose boots remain securely attached to the mobile platform during takeoff from the stack, preventing interference with other mobile platforms in the stack.

In one implementation, the dual-purpose boots are pre-arranged or otherwise placed on the mobile platform stacking structure, such that when a mobile platform (without the dual-purpose boots) is slid or dropped down along the pair of guide rails on the mobile platform stacking structure, the dual-purpose boots engage a bottom of respective support members of the mobile platform, providing impact absorption while simultaneously coupling to the bottom of the respective support members, such that the dual-purpose boots remain securely attached to the mobile platform during takeoff and landing operations.

In a further implementation, the dual-purpose boots are optimized to absorb an impact of a 5-kilogram mobile platform dropped from a height of one meter. The geometry of the dual-purpose boots is specifically designed to ensure that faces of the slotted spring contact each other before the material yields, acting as a strain limiter and preventing material failure. While the 5-kilogram weight at the height of one meter is specific to the implementations described herein, wherein each mobile platform in a stack weighs 5-kilograms and each mobile platform is dropped from a height of one meter or less during stacking, other weights and heights are contemplated herein, whereby the dual-purpose boots are designed specifically for a different particular weight and/or a different particular drop height.

In an additional implementation, the system includes one-time use crushable materials, such as aluminum or paper honeycomb, bubble wrap, foams, or 3D-printed crush structures in place of or integrated into the shock absorbing portion of the dual-purpose boots to achieve similar deceleration effects. These materials may be integrated to optimize weight, height, and material usage while maintaining impact absorbing capabilities.

An exemplary technical effect of the system, apparatus, and methods described herein with respect to the mobile platform stacking assembly and a mobile platform that includes the dual-purpose boots, is the provision of both impact absorbing during landing and structural support for stable stacking during transport or storage. Each dual-purpose boot is positioned at the lower end of a corresponding support member and is formed from a resilient (or crushable) material configured to deform under landing forces, thereby reducing the transmission of shock to the mobile platform body and sensitive onboard components. In addition to mitigating landing impact, the dual-purpose boots include a uniquely contoured lower surface with an ability to support multiple operational modes, such as landing, stacking, and guided alignment within a single integrated structure. The lower surface of the shock absorbing portion includes an opening or channel dimensioned to receive and slide along a vertically oriented stacking beam, thereby facilitating self-aligning engagement during storage or transport. Simultaneously, the lower surface is shaped to mechanically engage with an upper portion of a support member of a lower mobile platform, enabling stable and secure vertical stacking with minimal lateral movement, while also providing the necessary absorbing. Additionally, an outermost portion of the lower surface includes a flat landing interface, optimized to provide a stable contact footprint during a mobile platform’s descent and ground contact. This multifunctional design of the dual-purpose boot enhances the operational robustness of the mobile platform by reducing the need for separate cushioning and stacking components, streamlining deployment, improving durability during handling, conserving space during storage or bulk transport, reduces part count and assembly complexity, and enhances both the robustness and operational efficiency of the mobile platform system across different use cases.

Referring now to FIG. 1, a perspective view illustrating an example dual-purpose boot 100 is provided. The dual-purpose boot 100 includes two separate sections, engaging portion 102 and shock absorbing portion 104. While described herein as two separate sections, in some examples, an entirety of dual-purpose boot 100 is monolithically formed from elastomeric material. In some examples, the elastomeric material is natural rubber, styrene-butadiene rubber, nitrile rubber, ethylene propylene diene monomer, silicon rubber, butyl rubber, thermoplastic polyurethane, thermoplastic vulcanizates, thermoplastic rubber, neoprene, polyisoprene, and the like. In some examples, the dual-purpose boot 100 has a length of approximately 150 millimeters, a width of approximately 80 millimeters, and a height of approximately 50 millimeters. In some examples, these dimensions are selected to ensure compatibility with the mobile platform’s landing gear and to provide sufficient surface area for effective impact absorption. In some examples, in relative terms, the dual-purpose boot’s 100 dimensions are proportionate to a size of the landing gear (e.g., the support members) of the mobile platform, ensuring a snug fit that facilitates an interference fit mechanism. In some examples, a length of the dual-purpose boot 100 is approximately twice the width of the metal bars of the landing gear, allowing for adequate coverage and secure attachment. In some examples, a height of the dual-purpose boot 100 is designed to be approximately one-third of its length, providing a compact form factor that maintains the mobile platform’s aerodynamic profile while offering sufficient material volume for the incorporation of the slotted spring design. In some examples, a thickness of an outer wall of the dual-purpose boot 100 is approximately 5 millimeters to balance flexibility and structural integrity, allowing for controlled deformation under load conditions without compromising durability.

In some examples, the engaging portion 102 includes an axial opening (e.g., a first axial opening 106) that extends from a top of the engaging portion 102 to a bottom of the engaging portion 102 as represented by arrow 108 and the shock absorbing portion 104 includes an axial opening (e.g., a second axial opening 107) that extends from a bottom of a top of the shock absorbing portion 104 to a bottom of the shock absorbing portion 104 as represented by arrow 109.

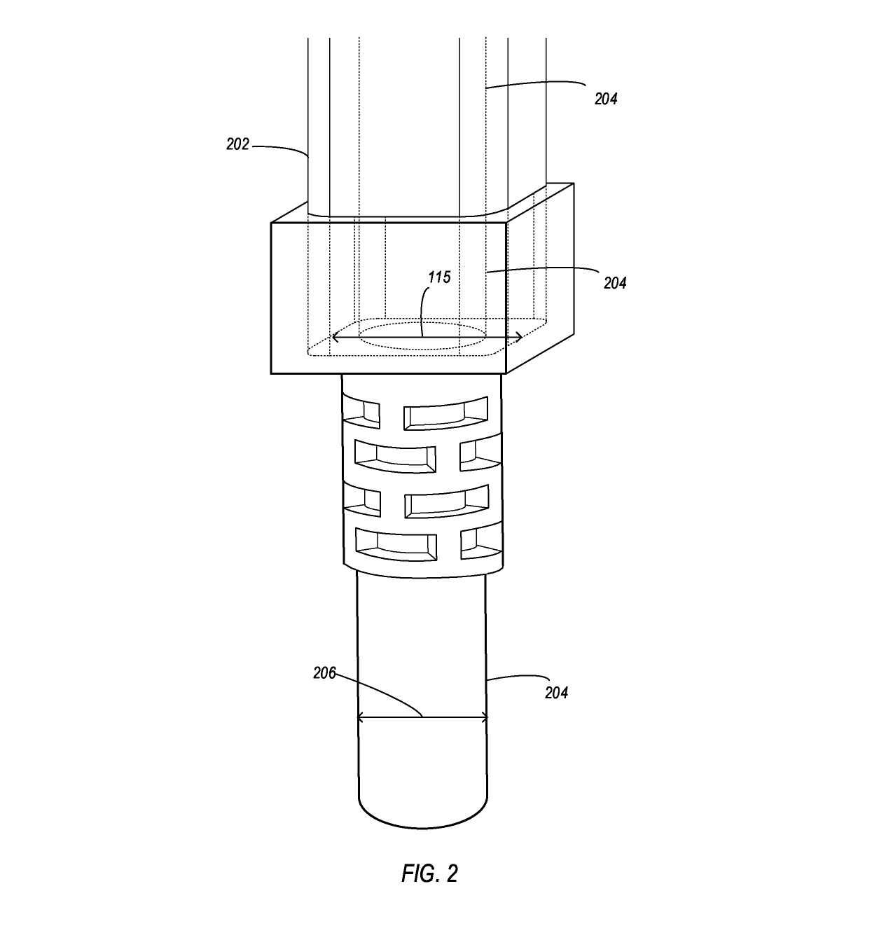

The first axial opening 106 is sized and shaped to receive an end of a support member, such as support member 202 shown in FIG. 2. While standard or basic shapes of the first axial opening 106 are contemplated herein, in some examples, the shape of the first axial opening 106 is specific to the shape of the support member that will extend through the first axial opening 106 to enable a better or tighter fit. In some examples, the dual-purpose boot 100 is attached to the support member 202 through the use of an interference fit mechanism. This design enables the dual-purpose boot 100 to slide over the support member 202, ensuring a secure attachment. The interference fit is achieved by designing the internal dimensions of the dual-purpose boot 100 (e.g., the first axial opening 106) to be slightly smaller in width than the external dimensions of the support member 202, creating a tight fit that holds the boots in place. This method facilitates easy attachment and detachment, allowing for straightforward maintenance and replacement while ensuring that the dual-purpose boot 100 remains securely attached during takeoff and landing operations. Additionally, the modular nature of this attachment system allows for potential integration with other mobile platform components. In some examples, the dual-purpose boot 100 is integrated into the support member 202 itself instead of being attachable/removable.

A lower surface of the first axial opening 106 includes a shoulder 112 that defines an area (e.g., represented by arrow 114) extending laterally between a perimeter of the first axial opening 106 and a perimeter of the second axial opening 107. In some examples, the shoulder 112 is sized to limit axial insertion of the support member 202 by preventing the support member 202 from entering the second axial opening 107. That is, the first axial opening 106 has a width (e.g., a first width 110) that is wider than a width (e.g., a second width 111) of the second axial opening 107, and the support member 202 has a width (e.g., a third width 115 shown in FIG. 2) that is less than or equal to the first width 110 and greater than the second width 111. Thus, as the support member 202 extends through the first axial opening 106, a bottom surface of the support member 202 engages the shoulder 112 and is prevented from extending any further (as further illustrated in FIG. 2).

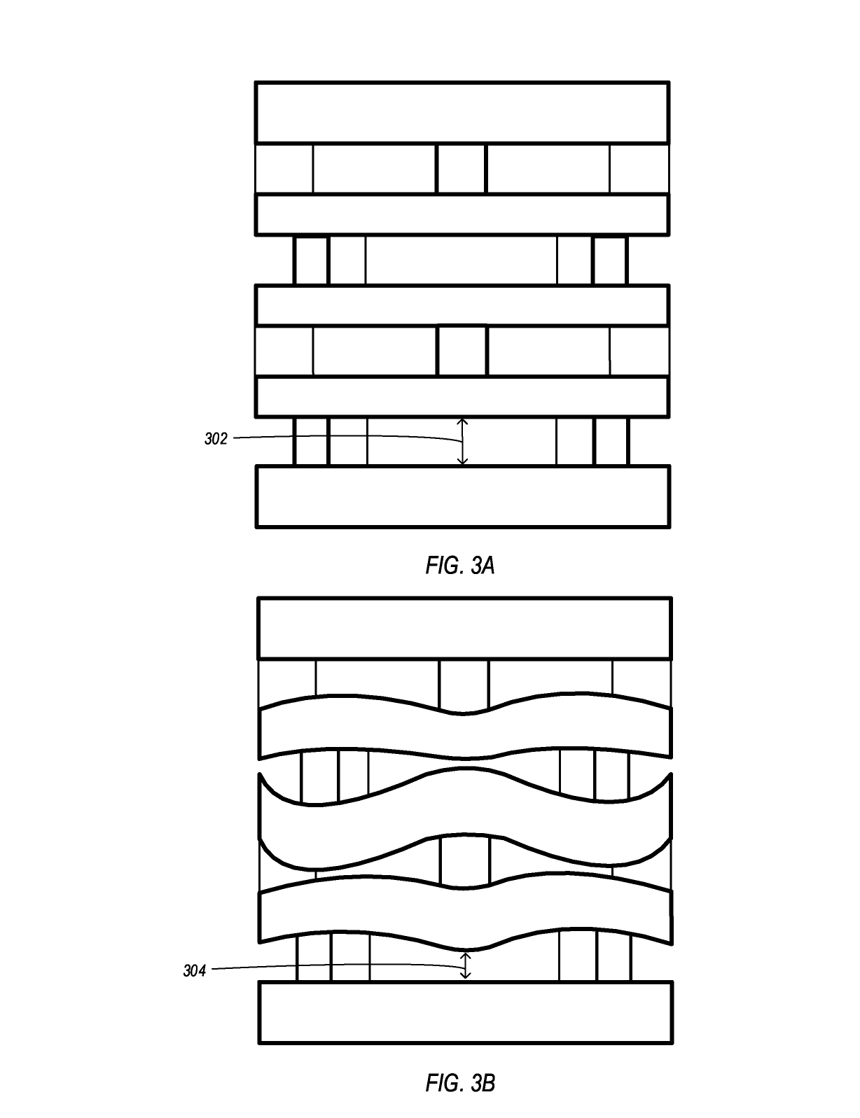

In some examples, the shock absorbing portion 104 includes a plurality of compression cavities 116 formed in a side wall of the shock absorbing portion 104. In some examples, each of the plurality of compression cavities 116 are deformable between a first height in an uncompressed state and a second height in a compressed state. For example, with reference now to FIGS. 3A and 3B, FIG. 3A illustrates the shock absorbing portion 104 in an uncompressed state in a slotted spring design. As such, as shown in FIG. 3A, each of the plurality of compression cavities 116 have a first height represented by arrow 302. FIG. 3B illustrates the shock absorbing portion 104 in the slotted spring design in a compressed state. As such, each of the plurality of compression cavities 116 now have a height smaller than the first height as represented by arrow 304. As shown in FIG. 3B, each of the plurality of compression cavities 116 have different compressed heights given their different sizes, locations, and shapes.

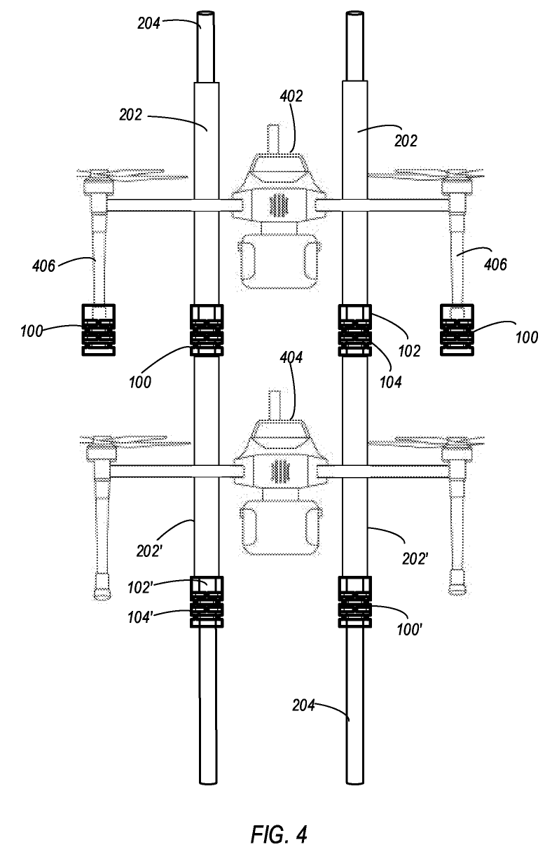

In some examples, the dual-purpose boot 100, and more specifically, the shock absorbing portion 104, is optimized to absorb an impact of a 5-kilogram mobile platform dropped from a height of one meter. Thus, in this example, each mobile platform in a stack weighs 5-kilograms and each mobile platform is dropped from a height of one meter or less during stacking of mobile platforms as shown in FIG. 4. Thus, the shock absorbing portion 104 is configured to absorb at least 49 joules of mechanical energy when subjected to axially loading. While the 5-kilogram weight at the height of one meter are just one specific set of parameters, other weights and heights are contemplated herein, whereby the dual-purpose boot 100 and/or the shock absorbing portion 104 are designed specifically for a different particular weight, a different particular drop height, and/or a different absorbent threshold number of joules of mechanical energy.

In some examples, each of the compression cavities 116 have a width of approximately 5 millimeters, a length of approximately 20 millimeters, and a depth of approximately 10 millimeters to ensure that the compression cavities 116 provide sufficient pathways for controlled deformation of the dual-purpose boot 100 material under load conditions. In some examples, the compression cavities 116 are incorporated into the slotted spring design of the shock absorbing portion 104 are dimensioned in relative terms to optimize impact absorption capabilities. In some examples, a width of each of the compression cavities 116 is approximately one-tenth of the dual-purpose boot’s 100 overall width, allowing for adequate flexing of the material. In some examples, a length of the compression cavities 116 is approximately one-fourth of the dual-purpose boot’s 100 length, ensuring sufficient pathways for controlled deformation. In some examples, a depth of the compression cavities 116 is approximately one-fifth of the dual-purpose boot's 100 height, contributing to the distribution of impact forces over a larger area. In some examples, these relative dimensions are selected to ensure that the compression cavities 116 provide effective deformation characteristics, increasing a time over which deceleration occurs and reducing the instantaneous G-forces experienced by the mobile platform during landing and/or stacking.

In some examples, the compression cavities 116 are configured in various shapes, such as circular, elliptical, or triangular, to modify deformation characteristics. In some examples, circular slots provide uniform stress distribution, while elliptical slots offer directional flexibility, enhancing impact absorption in specific directions. In some examples, triangular slots concentrate deformation at specific points, allowing for targeted energy absorption. In some examples, a staggered pattern for the compression cavities 116 provides uniform deformation across the spring, while a linear arrangement focuses energy absorption along a specific axis. In some examples, varying a density of the compression cavities 116, with more slots in high-stress areas and fewer in low-stress regions, optimizes material usage and performance. In some examples, in addition to or in place of the compression cavities 116, the shock absorbing portion 104 incorporates additional damping elements, such as viscoelastic materials or fluid-filled chambers, to further enhance impact absorption. In some examples, these additional damping elements are strategically placed within or adjacent to the compression cavities 116 to provide additional energy dissipation and reduce rebound effects during landing and stacking.

In some examples, the shock absorbing portion 104 includes removable or adjustable inserts within the compression cavities 116. In some examples, these inserts are made from materials with varying stiffness or damping properties. By changing which inserts are removed/adjusted, an overall flexibility and force absorption of the dual-purpose boot 100 can be modified on the fly without requiring obtaining another dual-purpose boot 100 with the needed/desired design of the compression cavities 116.

With continued reference to FIGS. 3A and 3B, the color gradient depicted therein represents the stress distribution across the slotted spring design. Areas of higher stress are indicated by warmer colors, while cooler colors denote regions of lower stress. This visualization provides an understanding of how the slotted spring design manages impact forces, ensuring that the material does not yield or bottom out under pressure. This visualization also demonstrates how the slotted design facilitates gradual deceleration by allowing the material to flex and absorb energy over an extended period, thereby reducing the instantaneous G-forces experienced by the mobile platform. The slotted spring design ensures that the faces of the plurality of compression cavities 116 contact each other before the material reaches its yield point, acting as a strain limiter and contributing to the reusability of the dual-purpose boots 100 over multiple landing and stacking cycles.

The modular nature of the slotted spring design, as shown in the examples of FIGS. 3A and 3B, allows for potential variations in compression cavity size, shape, and arrangement to accommodate different mobile platform weights and landing conditions. For example, heavier mobile platforms require larger and/or deeper slots to accommodate greater deformation and energy absorption, ensuring that the material can flex sufficiently to distribute impact forces over a larger area. This adaptability ensures that the dual-purpose boots 100 can be optimized for specific applications, providing a balance between flexibility, impact absorption, and durability. The use of TPU material, characterized by its low Young's modulus and Shore hardness of approximately 85, further enhances the performance of the slotted spring design by allowing significant deflection without permanent deformation.

With reference back to FIG. 2, in some examples, the first axial opening 106 and the second axial opening 107 define a continuous axial passage sized to allow axial movement of a guide rail 204 therethrough. For example, with reference now to FIG. 4, an illustration of a stacking of two mobile platforms 402 and 404 is provided. As shown in FIG. 4, two guide rails 204 extend vertically (e.g., from the ground, a platform, or a case) enabling the support members 202 of the first mobile platform 402 and the support members 202’ of the second mobile platform 404 to slide over a top of (e.g., down) the guide rails 204. In some examples, the guide rails 204 have a width (e.g., a fourth width 206 shown in FIG. 2) that is less than or equal to the second width 111 of the second axial opening 107 of the shock absorbing portion 104, and thus also less than the first width 110 of the first axial opening 106 of the engaging portion 102. As such, the guide rails 204 are enabled to extend all the way through the support members 202, and the first axial openings 106 of the engaging portions 102 and the second axial openings 107 of the shock absorbing portions 104 of each of the dual-purpose boots 100 of the first mobile platform 402, and continue to extend through the support members 202’, and the first axial opening 106’ and the second axial opening 107’ of the second mobile platform 404.

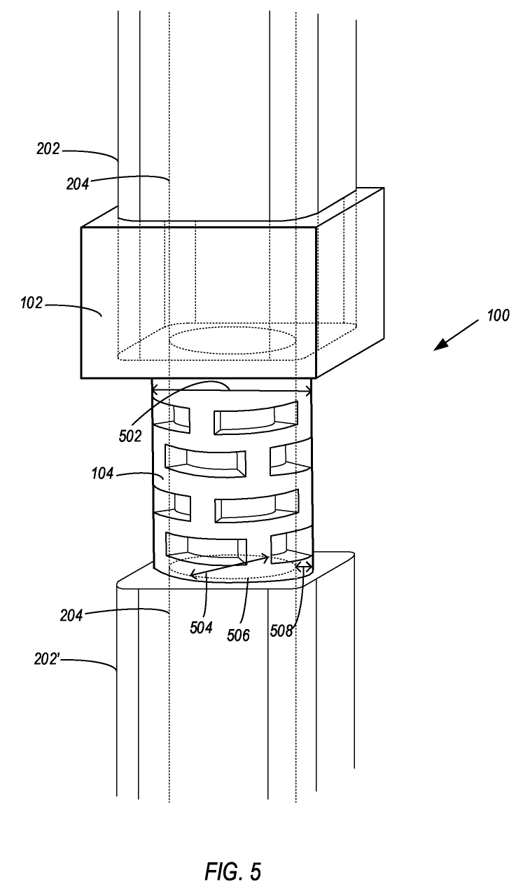

Further, as shown in the example of FIG. 4, the first mobile platform 402 has the dual-purpose boots 100 attached to each end of the supporting members 202. Thus, as the first mobile platform 402 is slid down the guide rails 204, the dual-purpose boots 100 on the supporting members 202 of the first mobile platform 402 engage a top surface of the supporting members 202’ of the second mobile platform 404. More specifically, and with reference to FIG. 5, a bottom surface (e.g., a second surface) of the shock absorbing portion 104 engages a top portion of the supporting member 202’, causing the shock absorbing portion 104 to absorb the impact created from the first mobile platform 402 being slid down the guide rails 204 and on top of (e.g., stacked) the second mobile platform 404. As described above, the shock absorbing portion 104 has the second axial opening 107 extending therethrough, enabling the guide rail 204 to pass all the way through the second axial opening 107. However, a width (e.g., a fifth width 502) of the shock absorbing portion 104 is larger than a width (e.g., a sixth width 504) of a guide opening 506 at a top of the supporting member 202’ in which the guide rail 204 extends through. Thus, an area 508 (represented by a double sided arrow) extending between a perimeter of the second axial opening 107 and a perimeter of the shock absorbing portion 104, creates a surface that engages the supporting member 202’.

In some examples, when the first mobile platform 402 is not being stacked and since the dual-purpose boots 100 are attached to a bottom of the supporting members 202 of the first mobile platform 402, the first mobile platform 402 can utilize the dual-purpose boots 100 as “landing gear” as the area 508 on the bottom surface of the shock absorbing portion 104 engages the ground (or any other surface) when landing or simply sitting at rest, enabling the shock absorbing portion 104 to absorb any impact or vibrations resulting therefrom.

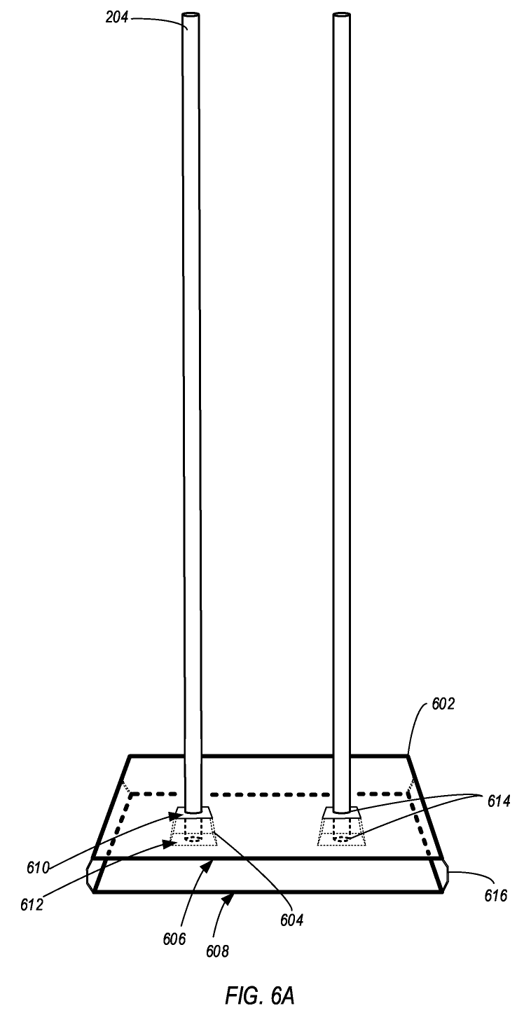

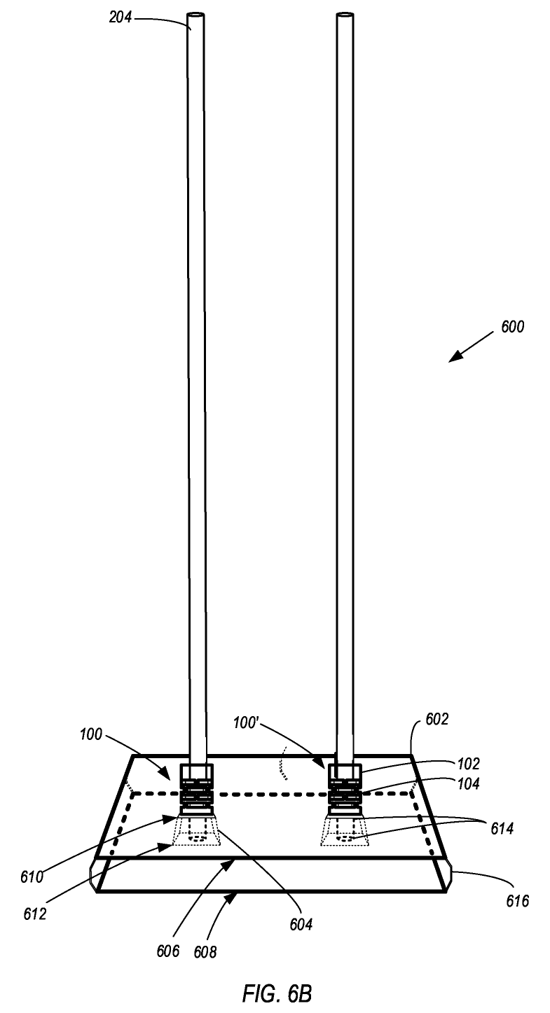

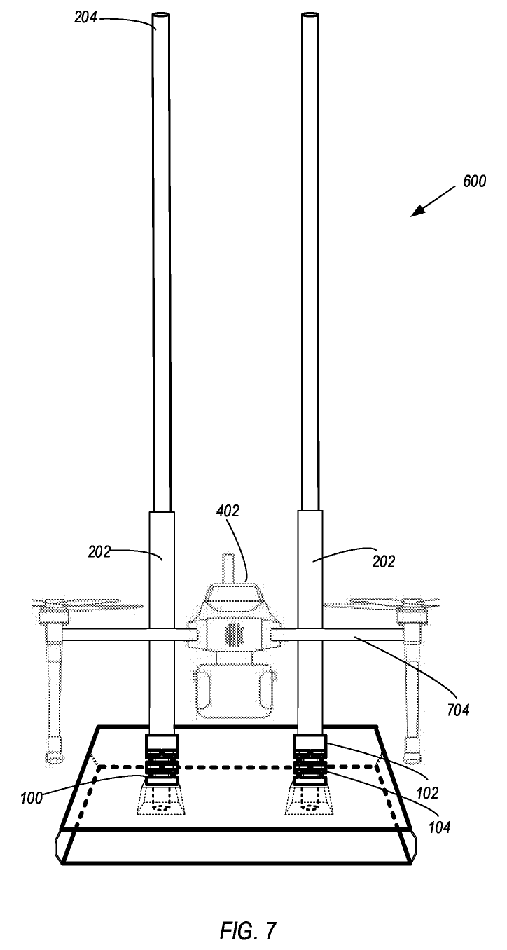

With reference now to FIG. 6A, an example mobile platform stacking structure 600 is shown. The mobile platform stacking structure 600 includes a base 602, a pair of guide rails (e.g., the guide rails 204) extending vertically from the base 602. In some examples, the base 602 further includes a pair of guide rail mounts 604 configured to support the pair of guide rails 204 upon insertion into respective ones of the pair of guide rail mounts 604. In some examples, the base 602 includes a top surface 606 and an opposing bottom surface 608, wherein each of the pair of guide rail mounts 604 extend from the bottom surface 608 to the top surface 606. In some examples, a bottom portion 612 of the pair of guide rail mounts 604 are physically coupled to the bottom surface 608 of the base 602. In some examples, the bottom portion 612 of the pair of guide rail mounts 604 are physically coupled to the bottom surface 608 of the base 602 and a top portion 610 of the pair of guide rail mounts 604 are coupled to the top surface 606 of the base. In some examples, the pair of guide rail mounts 604 include a guide rail opening 614 extending therethrough such that upon insertion into the respective ones of the pair of guide rail mounts 604, each of the pair of guide rails 204 extend through the top surface 606 of the base 602 into the respective ones of the guide rail mounts 604. In some examples, the base 602 further includes support brackets 616 respective corners of the base 602. The support brackets 616 provide separation of the top surface 606 and the bottom surface 608 of the base, enabling room for each of the pair of guide rail mounts 604 to extend therebetween as well as to provide additional support/absorption.

With reference now to the example of FIG. 6B, the mobile platform stacking structure 600 is shown with a pair of impact absorbing boots (e.g., a pair of the dual-purpose boot 100) attached thereto. As explained above, the dual-purpose boots 100 are configured to absorb a defined threshold of mechanical energy from axial impact resulting from a mobile platform (e.g., the first mobile platform 402) being slid down the pair of guide rails 204 onto the base 602. In some examples, each of the pair of the dual-purpose boots 100 include a first axial opening and a second axial opening (not shown in FIG. 6B) configured to allow axial movement of a respective one of the guide rails 204 therethrough. In some examples, the mobile platform stacking structure 600 includes the pair of dual-purpose boots 100 placed through the pair of guide rails 204 prior to the first mobile platform 402 being placed on the mobile platform stacking structure 600. In this example, the first mobile platform 402 do not include the dual-purpose boots 100 prior to being placed on the mobile platform stacking structure 600. In some examples, the pair of dual-purpose boots 100 rests on the top surface 606 of the base 602 or a respective top portion 610 of the pair of guide rail mounts 604. In the example wherein the dual-purpose boots 100 are pre-arranged/placed on the mobile platform stacking structure 600, when the first mobile platform 402 (without the dual-purpose boots 100) is slid or dropped down along the pair of guide rails 204 on the mobile platform stacking structure 600, the dual-purpose boots 100 engage a bottom of respective support members 202 of the first mobile platform 402 (as shown in FIG. 7), providing impact absorption for the first mobile platform 502 while simultaneously coupling the dual-purpose boots 100 to the bottom of the respective support members 202. In this example, based on the simultaneous coupling, the dual-purpose boots 100 remain securely attached to the first mobile platform 402 during takeoff and landing operations.

In some examples, a plurality of additional dual-purpose boots 100 are provided with the mobile platform stacking structure 600. Each of the plurality of additional dual-purpose boots 100 are specifically designed to fit a diameter of the pair of the guide rails 204 and to absorb a defined threshold of mechanical energy from axial impact resulting from a mobile platform being slid down the pair of guide rails 204 onto the base 602 from the height of the guide rails 204. In this example, the plurality of additional dual-purpose boots 100 are configured to be attached to support members of the mobile platforms prior to the mobile platforms being stacked along the pair of guide rails 204.

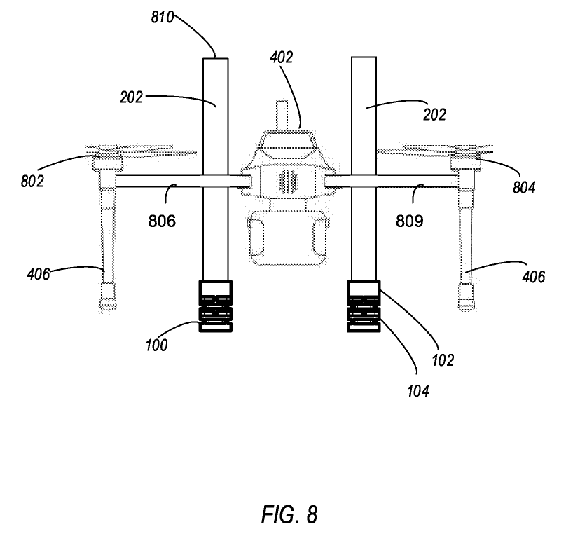

With continued reference to FIG. 7, in some examples, the first mobile platform 402 is slidably engaged with the pair of guide rails 204 via the pair of supporting members 202 coupled to opposing sides of the first mobile platform 402. In the following examples, the first mobile platform 402 already includes the pair of dual-purpose boots 100 coupled to an end of a corresponding supporting member 202 of the pair of supporting members 202 (e.g., as shown in FIG. 8) prior to the first mobile platform being placed on the mobile platform stacking structure 600.

With reference now to FIG. 8, an example mobile platform (e.g., the first mobile platform 402) is shown. The first mobile platform 402 includes a plurality of propeller assemblies that include a first pair of propeller assemblies 802 mounted to a first side of the first mobile platform 402 and a second pair of propeller assemblies 804 mounted to a second side of the first mobile platform 402 opposite the first side. As shown in FIG. 8, only one propeller assembly of the first pair of propeller assemblies 802 is shown. The other propeller assembly of the first pair of propeller assemblies 802 is positioned behind the first supporting member 202 on a similar plane to the propeller assembly of the first pair of propeller assemblies 802 shown in FIG. 8. Similarly, as shown in FIG. 8, only one propeller assembly of the second pair of propeller assemblies 804 is shown. The other propeller assembly of the second pair of propeller assemblies 804 is positioned behind the second supporting member 202 on a similar plane as the propeller assembly of the second pair of propeller assemblies 802 shown in FIG. 8.

In some examples, the first mobile platform 402 further includes a first supporting member 202 mounted to the first side of the first mobile platform 402 by a first mounting arm 806 between the first pair of propeller assemblies 802. In some examples, a second supporting member 202 is mounted on the second side of the first mobile platform 402 by a second mounting arm 808 between the second pair of propeller assemblies 804. In some examples, each of the first supporting member 202 and the second supporting member 202 include a first guide opening 810 extending therethrough. In some examples, the first guide opening 810 is configured to receive a corresponding guide rail 204 from the pair of guide rails 204 to enable the first mobile platform 402 to slide along the pair of guide rails 204. In some examples, the first mobile platform includes a first dual-purpose boot 100 coupled to an end of the first supporting member 202 and a second dual-purpose boot 100 coupled to an end of the second supporting member 202. In some examples, each of the first dual-purpose boot 100 and the second dual-purpose boot 100 include a second guide opening extending therethrough (not shown in FIG. 8). In some examples, the second guide opening is configured to receive the corresponding guide rail 204 from the pair of guide rails 204 to enable each of the first dual-purpose boot 100 and the second dual-purpose boot 100 to slide along a corresponding guide rail 204 of the pair of guide rails 204. In some examples, each of the first dual-purpose boot 100 and the second dual-purpose boot 100 is configured to absorb a defined threshold of mechanical energy from axial impact resulting from the first mobile platform 402 being dropped during stacking on, for example, the mobile platform stacking structure 600.

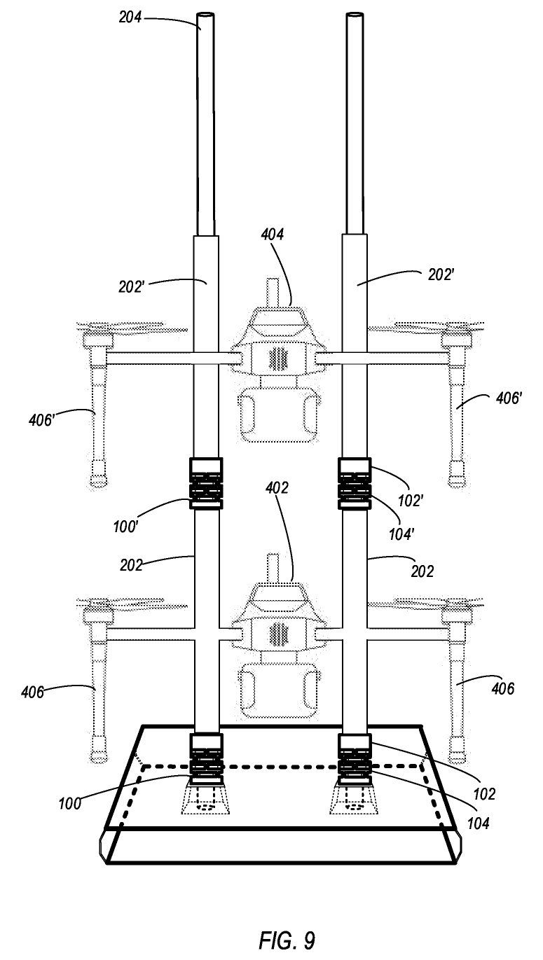

With reference now to FIG. 9, an illustration of an example stacking of two mobile platforms 402 and 404 on the mobile platform stacking structure 600 is provided. As shown in FIG. 8, the pair of guide rails 204 extend vertically (e.g., from the ground, a platform, or a case) enabling the support members 202 of the first mobile platform 402 and the support members 202’ of the second mobile platform 404 to slide over a top of (e.g., down) the pair of guide rails 204. In some examples, the pair of guide rails 204 have a width (e.g., a fourth width 206 shown in FIG. 2) that is less than or equal to the second width 111 of the second axial opening 107 of the shock absorbing portion 104, and thus also less than the first width 110 of the first axial opening 106 of the engaging portion 102. As such, the guide rails 204 are enabled to extend all the way through the support members 202, and the first axial openings 106 of the engaging portions 102 and the second axial openings 107 of the shock absorbing portions 104 of each of the dual-purpose boots 100 of the first mobile platform 402, and continue to extend through the support members 202’, and the first axial opening 106’ and the second axial opening 107’ of the second mobile platform 404.

Further, as shown in the example of FIG. 9, the first mobile platform 402 has the dual-purpose boots 100 attached to each end of the supporting members 202. Thus, as the first mobile platform 402 is slid down the guide rails 204, the dual-purpose boots 100 on the supporting members 202 of the first mobile platform 402 engage the top surface of the base 602 or the top portion 610 of the guide rail mounts 604. Further, as the second mobile platform 404 is slid down the guide rails 204, the dual-purpose boots 100 on the supporting members 202’ of the second mobile platform 404 engages a top surface of the supporting members 202 of the first mobile platform 402.

In some examples, while not shown in FIG. 9, a third mobile platform is provided such that the third mobile platform is slid down the guide rails 204, and the dual-purpose boots 100 attached to the supporting members 202 of the third mobile platform engage a top surface of the supporting members 202’ of the second mobile platform 404.

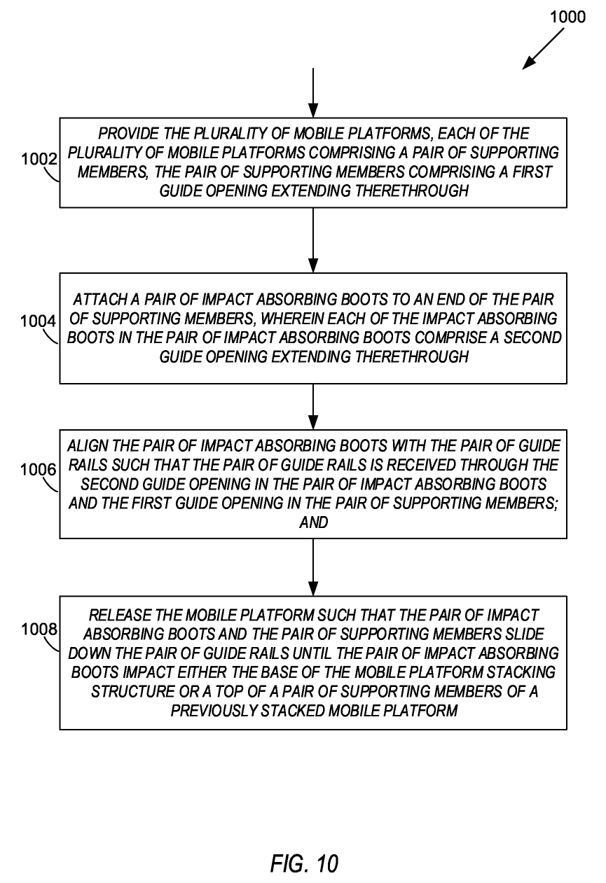

With reference now to FIG. 10, a method 1000 of stacking a plurality of mobile platforms on the mobile platform stacking structure 600 is provided. At 1002, a plurality of mobile platforms (e.g., the mobile platforms 402 and 404) is provided. In some examples, each of the plurality of mobile platforms include a pair of supporting members 202 and a pair of the dual-purpose boots 100 are attached to an end of the pair of supporting members 202, and the pair of supporting members 202 include a first guide opening 506 extending therethrough with each of the dual-purpose boots 100 including a second guide opening extending therethrough. As described herein, the operations of 1004-1008 are performed for each of the plurality of mobile platforms separately. At 606, the pair of dual-purpose boots 100 of one of the plurality of mobile platforms is aligned with the pair of guide rails 204, such that the pair of guide rails 204 is received through the second guide opening in the pair of dual-purpose boots 100 and the first guide opening in the pair of supporting members 202. At 608, the mobile platform of the plurality of mobile platforms is released such that the pair of dual-purpose boots 100 and the pair of supporting members 202 slide down the pair of guide rails 204 until the pair of dual-purpose boots 100 impact either the base 602 of the mobile platform stacking structure 600 or a top of a pair of supporting members 202 of a previously stacked mobile platform of the plurality of mobile platforms.

In some examples, a mobile platform stacking assembly includes a base, a pair of guide rails extending vertically from the base, and a mobile platform slidably engaged with the pair of guide rails via a pair of supporting members coupled to opposing sides of the mobile platform. The mobile platform stacking assembly further includes a pair of impact absorbing boots configured to absorb a defined threshold of mechanical energy from axial impact resulting from the mobile platform being slid down the pair of guide rails onto the base, each of the pair of impact absorbing boots comprising an first axial opening and the second axial opening configured to allow axial movement of a guide rail therethrough.

In some examples, a method of stacking a plurality of mobile platforms on a mobile platform stacking structure is provided. The mobile platform stacking structure includes a pair of guide rails extending vertically from a base of the mobile platform stacking structure. The method includes: providing the plurality of mobile platforms, each of the plurality of mobile platforms comprising a pair of supporting members, the pair of supporting members comprising a first guide opening extending therethrough, and for each of the plurality of mobile platforms: attaching a pair of impact absorbing boots to an end of the pair of supporting members, wherein each of the impact absorbing boots in the pair of impact absorbing boots comprise a second guide opening extending therethrough, aligning the pair of impact absorbing boots with the pair of guide rails such that the pair of guide rails is received through the second guide opening in the pair of impact absorbing boots and the first guide opening in the pair of supporting members, and releasing the mobile platform such that the pair of impact absorbing boots and the pair of supporting members slide down the pair of guide rails until the pair of impact absorbing boots impact either the base of the mobile platform stacking structure or a top of a pair of supporting members of a previously stacked mobile platform.

In some examples, a dual-purpose boot includes the following: an engaging portion comprising a first axial opening having a first width; a shock absorbing portion comprising a second axial opening having a second width that is shorter than the first width, the shock absorbing portion further comprising a plurality of lateral compression cavities configured to deform in a compressed state under axial impact; and a shoulder positioned between the engaging portion and the shock absorbing portion, wherein the shoulder is configured to limit axial insertion of a support member by preventing the support member from entering the second axial opening; wherein the first axial opening and the second axial opening are configured to allow axial movement of a guide rail therethrough, the end of the support member having a third width that is larger than the second width and smaller than the first width.

In some examples, a mobile platform configured to be stacked in a mobile stacking structure comprising a pair of guide rails extending vertically from a base is provided. The mobile platform includes a plurality of propeller assemblies, the plurality of propeller assemblies comprising a first pair of propeller assemblies mounted to a first side of the mobile platform and a second pair of propeller assemblies mounted to a second side of the mobile platform opposite the first side, a first supporting member mounted to the first side of the mobile platform by a first mounting arm between the first pair of propeller assemblies, a second supporting member mounted on the second side of the mobile platform by a second mounting arm between the second pair of propeller assemblies, each of the first supporting member and the second supporting member comprising a first guide opening extending therethrough, the first guide opening configured to receive a corresponding guide rail from the pair of guide rails to enable the mobile platform to slide along the pair of guide rails, a first impact absorbing boot coupled to an end of the first supporting member, and a second impact absorbing boot coupled to an end of the second supporting member, each of the first impact absorbing boot and the second impact absorbing boot comprising a second guide opening extending therethrough, the second guide opening configured to receive the corresponding guide rail from the pair of guide rails to enable each of the first impact absorbing boot and the second impact absorbing boot to slide along a corresponding guide rail of the pair of guide rails, wherein each of the first impact supporting boot and the second impact absorbing boot is configured to absorb a defined threshold of mechanical energy from axial impact resulting from the mobile platform being dropped during stacking.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A mobile platform stacking assembly comprising:
a base;
a pair of guide rails extending vertically from the base;
a mobile platform slidably engaged with the pair of guide rails via a pair of supporting members coupled to opposing sides of the mobile platform; and
a pair of impact absorbing boots configured to absorb a defined threshold of mechanical energy from axial impact resulting from the mobile platform being slid down the pair of guide rails onto the base, each of the pair of impact absorbing boots comprising a first axial opening and a second axial opening configured to allow axial movement of a guide rail therethrough.

2. The mobile platform stacking assembly of claim 1, wherein the mobile platform further comprising the pair of impact absorbing boots coupled to an end of a corresponding supporting member of the pair of supporting members.

3. The mobile platform stacking assembly of claim 1, wherein the base further comprises a pair of guide rail mounts configured to support the pair of guide rails upon insertion into respective ones of the pair of guide rail mounts, wherein the pair of guide rail mounts are physically coupled to the base.

4. The mobile platform stacking assembly of claim 3, wherein the base further comprise a top surface and an opposing bottom surface, wherein each of the pair of guide rail mounts extend from the bottom surface to the top surface, wherein a bottom portion of the pair of guide rail mounts are physically coupled to the bottom surface of the base, and wherein a top portion of the pair of guide rail mounts are physically coupled to the top surface of the base.

5. The mobile platform stacking assembly of claim 4, wherein the pair of guide rail mounts comprise a guide rail opening extending therethrough such that upon insertion into the respective ones of the guide rail mounts, each of the pair of guide rails extend through the top surface of the base into the respective ones of the guide rail mounts.

6. The mobile platform stacking assembly of claim 5, wherein the pair of impact absorbing boots are placed through the pair of guide rails such that the pair of impact absorbing boots rest on the top surface of the base or a respective top portion of the pair of guide rail mounts.

7. The mobile platform stacking assembly of claim 1, wherein each of the pair of supporting members comprises:
a first end and an opposing second end; and
a first guide opening extending from the first end to the second end, the first guide opening configured to receive a corresponding guide rail from the pair of guide rails to enable the supporting member to slide along the corresponding guide rail.

8. The mobile platform stacking assembly of claim 7, wherein each of the impact absorbing boots in the pair of impact absorbing boots are coupled to the second end of a corresponding supporting member from the pair of supporting members, each of the impact absorbing boots comprising a second guide opening extending therethrough, the second guide opening configured to receive the corresponding guide rail from the pair of guide rails to enable the impact absorbing boot to slide along the corresponding guide rail.

9. The mobile platform stacking assembly of claim 8, wherein the pair of guide rails extend to a first height from the base, and wherein the pair of the impact absorbing boots are configured to absorb an impact of the mobile platform dropped from the first height.

10. The mobile platform stacking assembly of claim 9, wherein the first height is one meter and wherein the mobile platform weighs 5-kilograms.

11. The mobile platform stacking assembly of claim 1, further comprising a second mobile platform slidably engaged with the pair of guide rails via a second pair of supporting members coupled to opposing sides of the second mobile platform, the second mobile platform further comprising a second pair of impact absorbing boots coupled to an end of a corresponding supporting member of the second pair of supporting members, the second pair of impact absorbing boots configured to absorb a defined threshold of mechanical energy from axial impact resulting from the second mobile platform being slid down the pair of guide rails onto the pair of supporting members of the mobile platform.

12. The mobile platform stacking assembly of claim 11, further comprising a third mobile platform slidably engaged with the pair of guide rails via a third pair of supporting members coupled to opposing sides of the third mobile platform, the third mobile platform further comprising a third pair of impact absorbing boots coupled to an end of a corresponding supporting member of the third pair of supporting members, the third pair of impact absorbing boots configured to absorb a defined threshold of mechanical energy from axial impact resulting from the third mobile platform being slid down the pair of guide rails onto the second pair of supporting members of the second mobile platform.

13. The mobile platform stacking assembly of claim 1, wherein each impact absorbing boot in the pair of impact absorbing boots are specifically designed to fit a diameter of the pair of guide rails and to absorb a defined threshold of mechanical energy from axial impact resulting from a mobile platform being slid down the pair of guide rails onto the base from a height of the guide rails, wherein each impact absorbing boot in the pair of impact absorbing boots are configured to be attached to support members of mobile platforms prior to the mobile platforms being stacked along the pair of guide rails.

14. A method of stacking a plurality of mobile platforms on a mobile platform stacking structure, the mobile platform stacking structure comprising a pair of guide rails extending vertically from a base of the mobile platform stacking structure, the method comprising:
providing the plurality of mobile platforms, each of the plurality of mobile platforms comprising a pair of supporting members, the pair of supporting members comprising a first guide opening extending therethrough;
for each of the plurality of mobile platforms:
attaching a pair of impact absorbing boots to an end of the pair of supporting members, wherein each of the impact absorbing boots in the pair of impact absorbing boots comprise a second axial opening extending therethrough;
aligning the pair of impact absorbing boots with the pair of guide rails such that the pair of guide rails is received through the second axial opening in the pair of impact absorbing boots and the first guide opening in the pair of supporting members; and
releasing the mobile platform such that the pair of impact absorbing boots and the pair of supporting members slide down the pair of guide rails until the pair of impact absorbing boots impact either the base of the mobile platform stacking structure or a top of a pair of supporting members of a previously stacked mobile platform.

15. The method according to claim 14, wherein the pair of impact absorbing boots are configured to absorb a defined threshold of mechanical energy from axial impact resulting from the mobile platform being slid down the pair of guide rails onto the base of the mobile platform stacking structure or the top of the pair of supporting members of the previously stacked mobile platform.

16. The method according to claim 14, wherein the pair of guide rails extend to a first height from the base of the mobile platform stacking structure, wherein the pair of the impact absorbing boots absorb an impact of the mobile platform dropped from the first height.

17. The method according to claim 16, wherein the first height is one meter, and the mobile platform weighs 5-kilograms.

18. A mobile platform configured to be stacked in a mobile stacking structure comprising a pair of guide rails extending vertically from a base, the mobile platform comprising:
a plurality of propeller assemblies, the plurality of propeller assemblies comprising a first pair of propeller assemblies mounted to a first side of the mobile platform and a second pair of propeller assemblies mounted to a second side of the mobile platform opposite the first side;
a first supporting member mounted to the first side of the mobile platform by a first mounting arm between the first pair of propeller assemblies;
a second supporting member mounted on the second side of the mobile platform by a second mounting arm between the second pair of propeller assemblies, each of the first supporting member and the second supporting member comprising a first guide opening extending therethrough, the first guide opening configured to receive a corresponding guide rail from the pair of guide rails to enable the mobile platform to slide along the pair of guide rails;
a first impact absorbing boot coupled to an end of the first supporting member; and
a second impact absorbing boot coupled to an end of the second supporting member, each of the first impact absorbing boot and the second impact absorbing boot comprising a second axial opening extending therethrough, the second axial opening configured to receive the corresponding guide rail from the pair of guide rails to enable each of the first impact absorbing boot and the second impact absorbing boot to slide along a corresponding guide rail of the pair of guide rails, wherein each of the first impact absorbing boot and the second impact absorbing boot is configured to absorb a defined threshold of mechanical energy from axial impact resulting from the mobile platform being dropped during stacking.

19. The mobile platform of claim 18, wherein the pair of guide rails extend to a first height from the base of the mobile platform stacking structure, and wherein each of the first impact absorbing boot and the second impact absorbing boot absorb an impact of the mobile platform dropped from the first height.

20. The mobile platform of claim 19, wherein the first height is one meter, and the mobile platform weighs 5-kilograms.
